(19) United States
(12) Patent Application Publication
(10) Pub. No.: US 2006/0097915 A1
(43) Pub. Date: May 11, 2006

(54) Method for the acquisition of a radio-navigation signal by satellite

(75) Inventors: Nicolas Martin, Bourg Les Valence (FR); Valery Leblond, Valence (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/544,914

(22) PCT Filed: Mar. 12, 2004
(86) PCT No.: PCT/EP04/50298

§ 371 Date: Aug. 9, 2005

(30) Foreign Application Priority Data
Apr. 15, 2003 (FR) 03/04719

(51) Int. Cl. G01S 5/14

(52) U.S. Cl. 342/357.15

(57) ABSTRACT

The invention relates to a method of acquisition of radio signals transmitted in particular by a satellite-based positioning system having a subcarrier, the acquisition of the signals being performed by a receiver having a channel for carrier correlation in-phase and quadrature, between the signal received and two respective in-phase and quadrature local carriers; a channel for subcarrier correlation on the basis of the signals at the output of the channel for carrier correlation with a local subcarrier; a channel for code correlation on the basis of the signals at the output of the channel for subcarrier correlation with the local codes provided by a digital generator of local codes; wherein in a first phase of acquisition, the channel for subcarrier correlation comprises two channels, in-phase and quadrature, between the signals at the output of the carrier correlation channel and two respective local subcarriers, in-phase and quadrature, with respect to the local code that are generated by a digitally controlled subcarrier local oscillator, the receiving being configured in such a way that in this first phase of acquisition of the signals, an energy search is performed by the detection of an unambiguous correlation peak.

The invention relates to a method of acquisition of radio signals in particular those transmitted by the satellite-based positioning systems of GPS (Global Positioning System), Galileo, GLONASS (Global Navigation Satellite System, Russion definition) type.

Satellite positioning systems employ, for pinpointing, several satellites that transmit their positions via radio signals and a receiver placed at the position to be pinpointed, estimating the distances, called pseudo-distances, that separate it from the satellites on the basis of the propagation times of the satellite signals picked up and performing the pinpointing operation by triangulation. The more precisely the satellite positions are known by the receiver and the more precise the measurements of the pseudo-distances made by the receiver are, the more precise is the pinpointing.

The positions of the satellites are determined on the basis of a network of ground tracking stations independent of the positioning receivers. These positions are communicated to the positioning receivers via the satellites themselves, by data transmission.

The pseudo-distances are deduced by the positioning receivers from the apparent delays exhibited by the received signals relative to the clocks of the satellites, which are all synchronous.

Although the precision in knowing the positions of the satellites of the positioning system is independent of the performance of a positioning receiver, this is not the case for the precision of the pseudo-distance measurements, which depends on the precision of the measurement of the signal propagation times at the receiver.

Radio signals transmitted by satellites travel large distances and, since they are transmitted at limited power levels, reach the receivers with very low power levels that are buried in radio noise due to the physical environment. To make it easier to receive them, it has been attempted to make them the least sensitive possible to narrow-band interference, by increasing their bandwidths by means of the band spreading technique.

The signals transmitted by the satellites are formed by modulating the carrier of the signal with a spreading code formed by a pseudo-random binary sequence. Thus, the satellite signals allow two types of measurement so as to locate the receiver. Moreover, the modulation of the carrier by a spreading code spreads the spectrum, thereby increasing the resistance of the system to jamming. Also, in addition, this makes it possible to segregate the satellites (by using a different code per satellite).

In reception, the binary information contained in a satellite radio signal of a positioning system are extracted by two demodulations performed simultaneously, a first demodulation with the aid of a carrier generated locally by an oscillator driven by a frequency or phase lock loop PLL making it possible to transpose the signal received into base band and a second demodulation with the aid of the pseudo-random binary sequence generated locally by a pseudo-random binary sequence generator driven by a code lock loop DLL (also known as a delay lock loop) making it possible to despread the signal received.

The propagation times of the signals received are manifested, in reception, by delays affecting the pseudo-random binary sequences present in the signals received and the carrier modulating the signal received.

The delays affecting the pseudo-random binary sequences are accessible, modulo the period of one of their binary sequences, at the level of the signals slaving the code lock loops or DLLs. The delays noted by these loops allow unambiguous or slightly ambiguous measurements of the propagation times of the pseudo-random binary sequences since the number of whole pseudo-random sequences flowing during the journeys of the signals is relatively small. One speaks of code measurements.

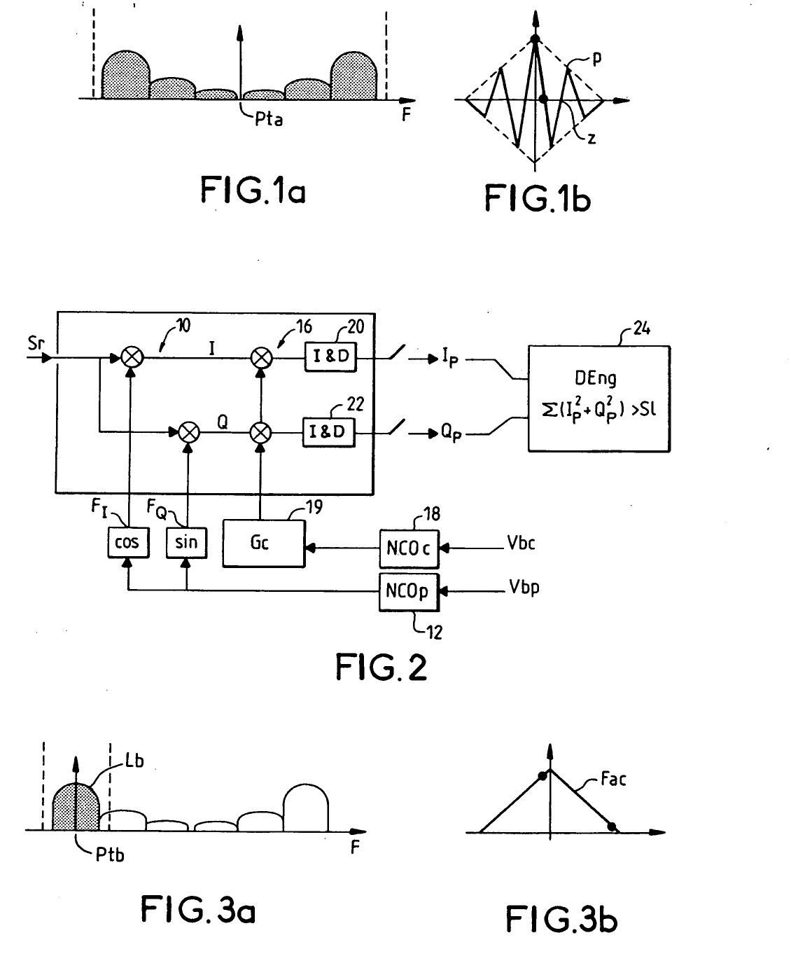

Generally the modulation used in satellite-based navigation systems is a modulation of BPSK type, “Binary Phase Shift Keying” or square modulation whose spectrum exhibits a single main lobe with adjacent side lobes. In order to improve the navigation performance, among other things resistance to jamming and precision of measurement of the position of the receiver, the new satellite-based navigation systems propose the use of a modulation of BOC “Binary Offset Carrier” type, or modulation on carrier with double shift, whose spectrum exhibits two main lobes that are spaced apart. FIG. 1a represents such a modulation spectrum of BOC type and FIG. 1b shows the shape of the autocorrelation function of such a BOC signal. The modulation of BOC type may be preferred to BPSK modulation since it allows a different use of the available band. For example, during military applications, this makes it possible to recover energy when the band used by the BPSK modulation at the center is jammed. For civil applications, it renders the radio navigation system compatible with American systems which use different bands. Moreover, with the modulation of BOC type, the performance of the receiver is improved since the spectrum is more spread.

Each signal transmitted by a visible satellite and received by the antenna must be demodulated by the receiver, so as to deduce therefrom a measurement of propagation time, of Doppler, and possibly of data transmitted.

The demodulation consists in slaving a locally generated signal, the image of the signal received from the satellite considered characterized by an actual spreading code and a carrier, by searching for the maximum of the correlation between this signal received and the local signal.

The slaving is performed by a carrier loop, which drives the phase of the local carrier, and by a code loop which drives the position (or phase) of the local code. The carrier loop measures a deviation of carrier phase between the local signal and the signal received by virtue of the correlation with a carrier quadrature local signal. The code loop measures a code phase deviation between the local signal and the signal received by virtue of the correlation with local signals, modulated by derived codes (early, late or delta).

As soon as the slaving has converged, the measurements of Doppler and of propagation time are formulated on the basis respectively of the frequency of the local carrier and of the position of the local code.

The measurement errors originate from the presence in the signal received Sr, in addition to the useful signal of the satellite considered, of the signals of the other satellites and of noise of various origins (thermal, quantization, interference etc) which disrupt the slaving and induce synchronization errors between the local signal and the signal received.

The aim of the acquisition phase is to initialize the operation of the tracking loops, since at the start neither the position of the code received, nor the value of the Doppler are known precisely. Now, the loops operate only if the position of the code and the Doppler are close to that of the useful signal of the satellite considered. If one of the deviations is too large the null correlation gives no more information (no energy detected E), and the slaving can no longer operate.

For this purpose, during a first phase of so-called acquisition a search is performed for a correlation peak between the local signal and the signal received, in a two-dimensional space, by trying out several assumptions on the phase of the code and on the value of the Doppler, with a sampling interval fine enough not to miss the peak. Once a peak has been found, the search for the code and for the Doppler is refined by decreasing the sampling interval, around the detected peak. When the precision obtained is deemed sufficient the loops are closed, the latter converging to the correlation maximum: we then switch to the tracking phase.

FIG. 2 shows the schematic of a satellite-based positioning receiver of the prior art during a first phase of acquisition with a signal received of BPSK type. The receiver comprises a channel for carrier correlation 10, in-phase and quadrature, between the signal received Sr and two respective local carriers F_{I}, F_{Q}. These quadrature local carriers (sin, cos) are generated by a carrier digitally controlled oscillator 12 (NCO p) of the receiver.

The signals I, Q at the output of the carrier correlation channel are then correlated in a code correlation channel 16 with the local code, punctual and delta, provided by a digitally controlled code carrier oscillator NCO c 18 and a local code generator Gc 19.

The signals output by the code correlation channels 16 are then integrated by a respective code integrator 20, 22 so as to provide signals I_{P} and Q_{P} to an energy detection DEng 24 for the detection of the acquisition of the signal.

The sum of the energies provided by the correlation channels of the receiver of FIG. 2 is given by the relation:
EΣ(I_{P}²+Q_{P}²)

The detection of the signal is considered to be obtained when this energy E exceeds a predetermined energy threshold SI.

Nevertheless, the modulation of BOC type comprises drawbacks. Specifically, the acquisition of a signal of BOC type is more difficult than that of a signal of BPSK type on account of the oscillations of the autocorrelation function. On the one hand, the zeros z of the autocorrelation function (see FIG. 1b) might give rise to missed detections (no energy detected). On the other hand, the multiple peaks p induce an ambiguity, when seeking to slave to a local correlation maximum, that has to be resolved subsequently.

A solution for alleviating this drawback consists in processing just a single main lobe Lb after analog filtering. FIG. 3a shows the spectrum of the resulting signal after filtering and FIG. 3b the resulting autocorrelation function after decentering of the local frequency. The processing of a single lobe makes it possible to recover a correlation function without oscillation. However, this solution leads to a loss of half the energy of the signal, thereby correspondingly increasing the acquisition threshold. Furthermore this makes it necessary to filter the signal and to review the processing of the signal (decentered carrier).

In order to alleviate the drawbacks of the radio navigation receivers of the prior art, the invention proposes a method of acquisition of radio signals transmitted in particular by a satellite-based positioning system comprising at least one subcarrier, the acquisition of the signals being performed by a receiving having:
a channel for carrier correlation, in-phase and quadrature, between the signal received and two respective in-phase and quadrature local carriers generated by a digitally controlled carrier local oscillator;
a channel for subcarrier correlation on the basis of the signals at the output of the channel for carrier correlation with a local subcarrier;
a channel for code correlation on the basis of the signals at the output of the channel for subcarrier correlation with the local codes provided by a digital generator of local codes;
   characterized in that in a first phase of acquisition, the channel for subcarrier correlation comprises two channels, in-phase and quadrature, between the signals at the output of the carrier correlation channel and two respective local subcarriers, in-phase and quadrature, with respect to the local code that are generated by a digitally controlled subcarrier local oscillator, the receiver being configured in such a way that in this first phase of acquisition of the signals, an energy search is performed by the detection of a correlation peak.

In a variant of the method of acquisition according to the invention, the receiver is configured in such a way that, in the first phase of acquisition of the signals, the phase of the subcarrier of the signal received is eliminated by summing the in-phase and quadrature powers of subcarriers at the outputs of correlation channels then in the same way, a search for an unambiguous correlation peak is performed.

In a second phase of acquisition of the signal received, a slaving of the loops is carried out on the basis of the outputs of the correlators causing convergence of the local code to the maximum of the code correlation peak, independently of the subcarrier.

The novel idea is to eliminate the subcarrier in the same way as the carrier is eliminated, after coherent integration, by summation of the energies gathered on the in-phase and quadrature correlation channels. For this purpose two local subcarriers, in-phase and quadrature, are generated in addition to the two local carriers, in-phase and quadrature, and the local codes (punctual, early, late or delta).

The method according to the invention may be implemented according to two processes:
In a first process the local code and the local subcarrier are synchronous. The phase of the local subcarrier is a multiple of the local code. The two phases arise from the same digitally controlled local oscillator (NCO) controlled in terms of speed and operating as an integrator.
In a second process, the local code and the local subcarrier are asynchronous.

The receiver furthermore provides, in a known manner, on the basis of the integrated signals at the output of the code correlation channel, the carrier speed, subcarrier speed and code speed for controlling the respective digitally controlled oscillators generating the carriers, subcarriers and local codes. the invention will be better understood with the aid of exemplary embodiments of receivers implementing the method of acquisition according to the invention, with reference to the appended drawings, in which:

FIGS. 1a and b, already described, show respectively a signal of BOC type and the autocorrelation function of a receiver of the prior art;

FIG. 2, already described, shows the schematic of a satellite-based positioning receiver of the prior art during the acquisition phase;

FIGS. 3a and 3b, already described, show respectively the spectrum of the signal of BOC type after filtering of one of the lobes and the resulting autocorrelation function after decentering of the local frequency;

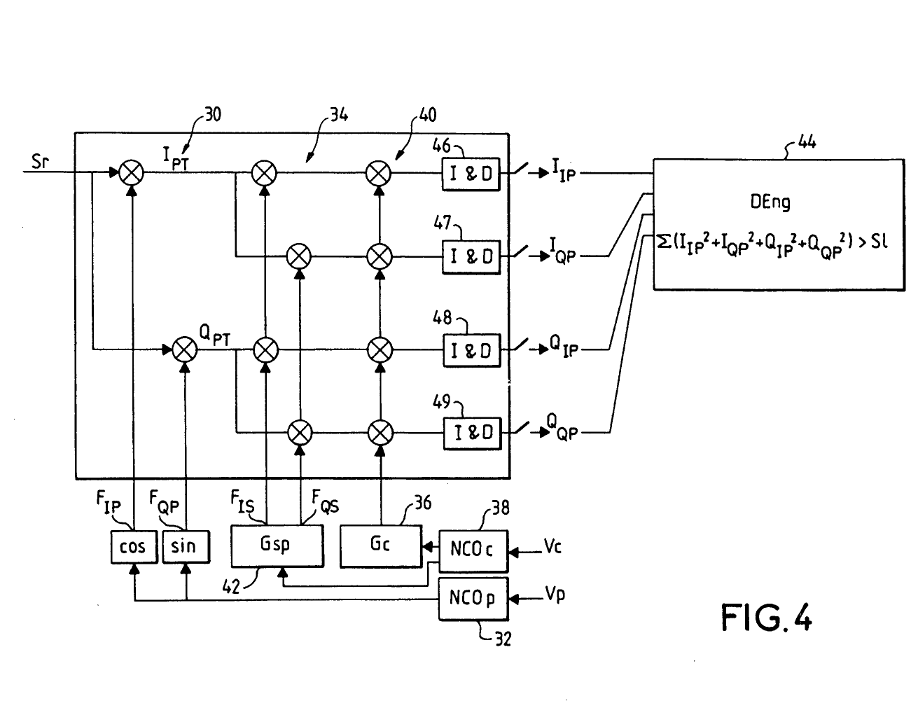

FIG. 4 shows the schematic of a receiver according to the invention during the acquisition phase;

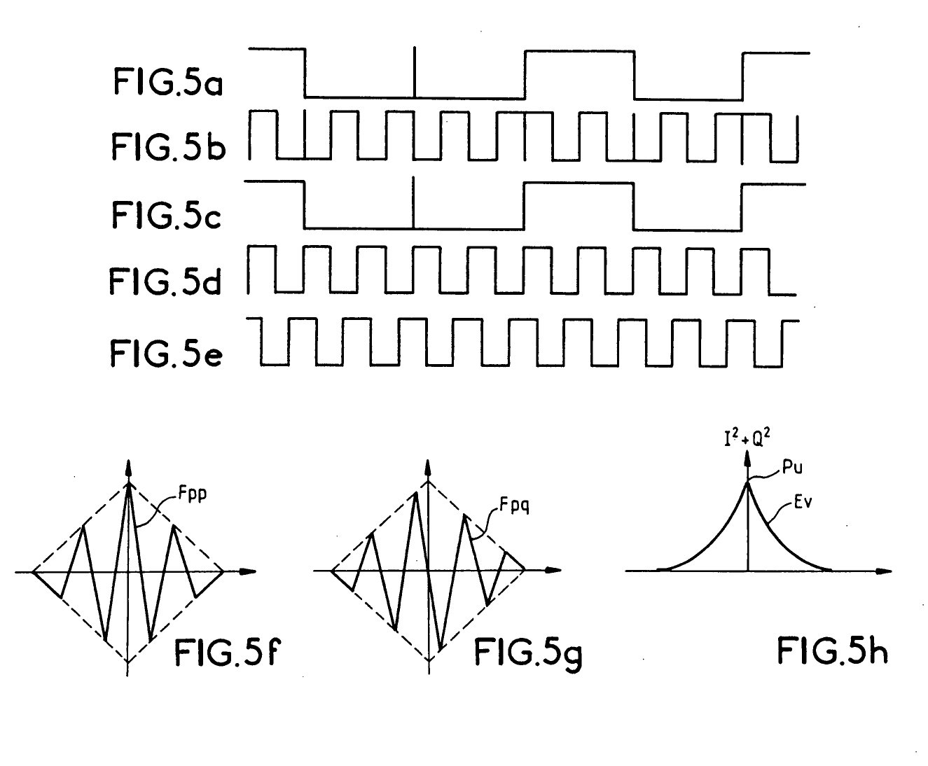

FIGS. 5a, 5b show respectively the code received of BPSK type without modulation by the subcarrier and the code received of BOC type with the modulation by the subcarrier of the receiver of FIG. 4, according to the invention;

FIGS. 5c, 5d and 5e show respectively the local code and the two local subcarriers, in-phase and quadrature, of the receiver of FIG. 4, according to the invention;

FIGS. 5f, 5g and 5h respectively represent the autocorrelation function with the in-phase subcarrier, with the quadrature subcarrier and the envelope of the energy detection at the output of the correlation channels;

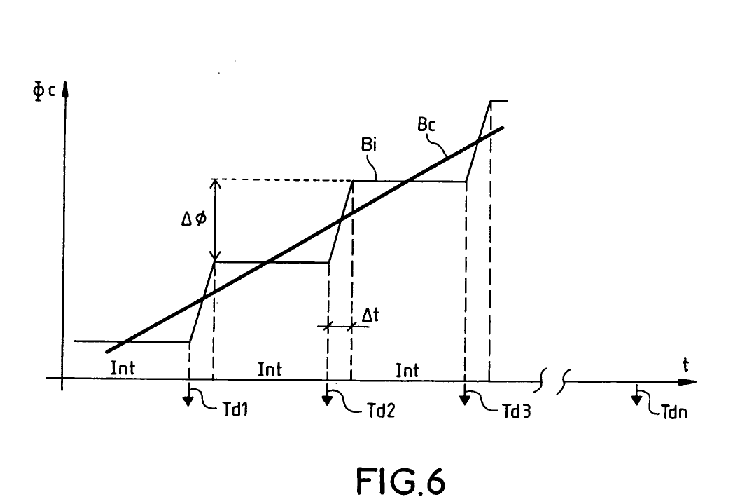

FIG. 6 shows curves representing the phase of the local code Φc as a function of time t in the phase of acquisition of the receiver according to the invention;

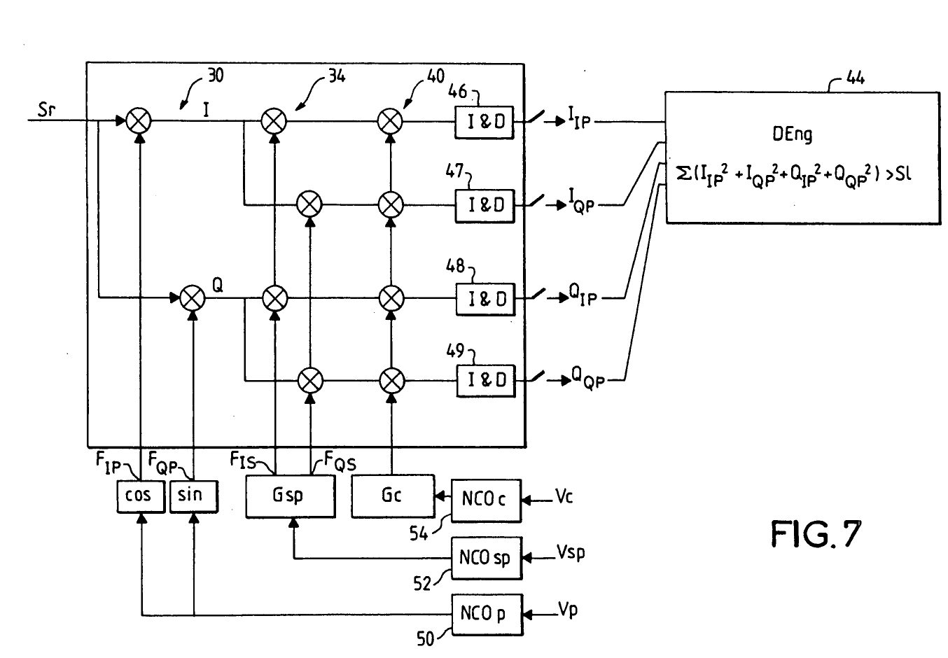

FIG. 7 shows another receiver, according to the invention, with a local code and local subcarriers that are asynchronous;

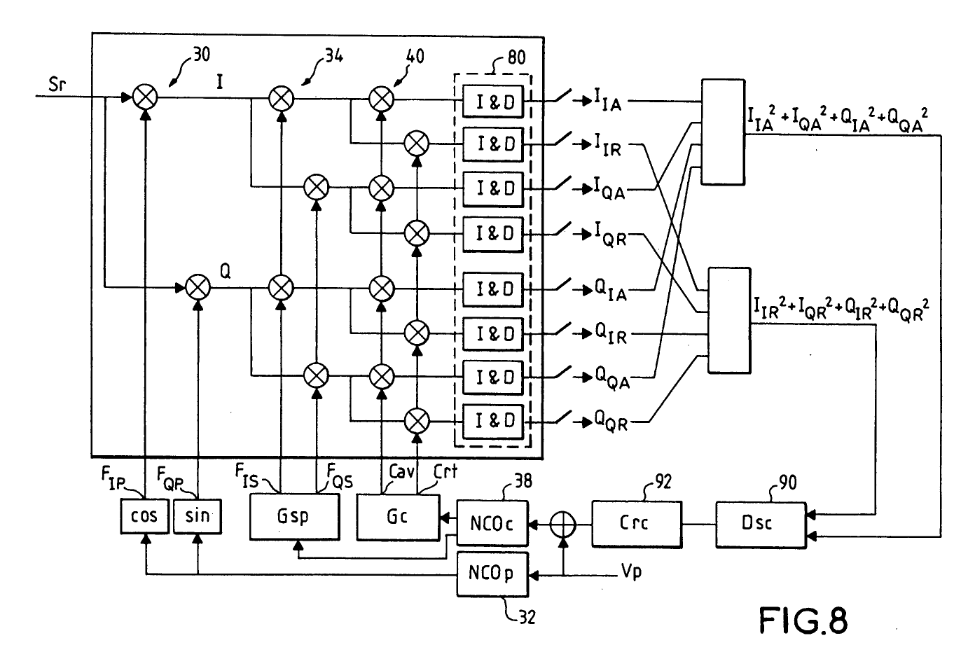

FIG. 8 shows the receiver of FIG. 4 outside of the phase of transition to tracking in the case where the local code and the local subcarrier are synchronous;

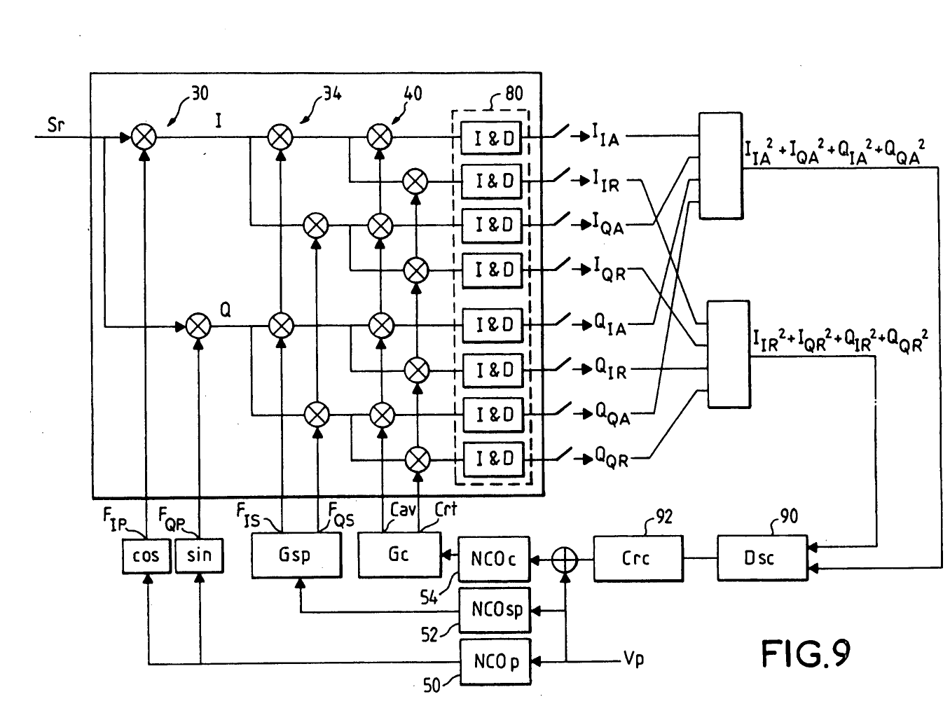

FIG. 9 shows a receiver, according to the invention, comprising three digitally controlled oscillators during the phase of transition to tracking in the case where the local code and the local subcarrier are asynchronous;

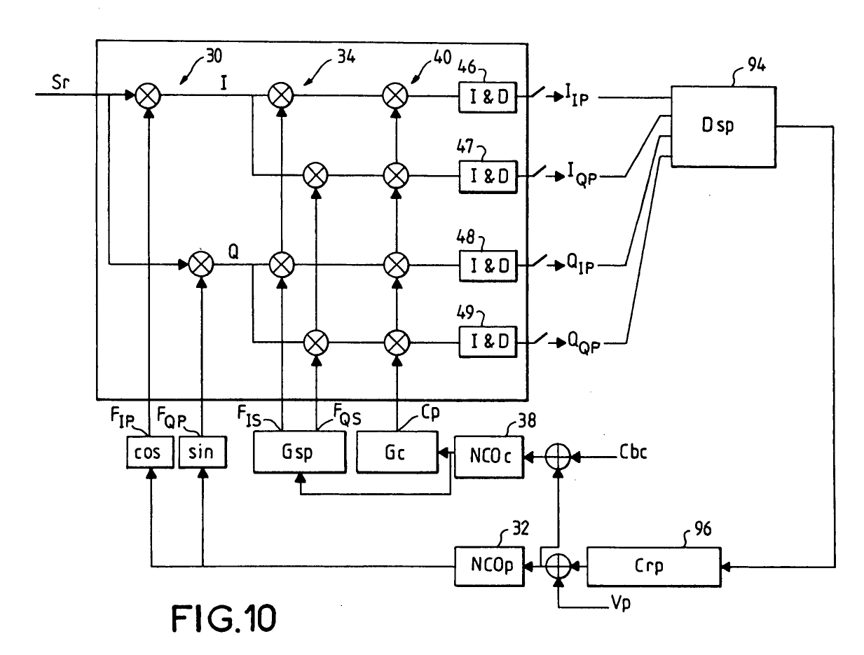

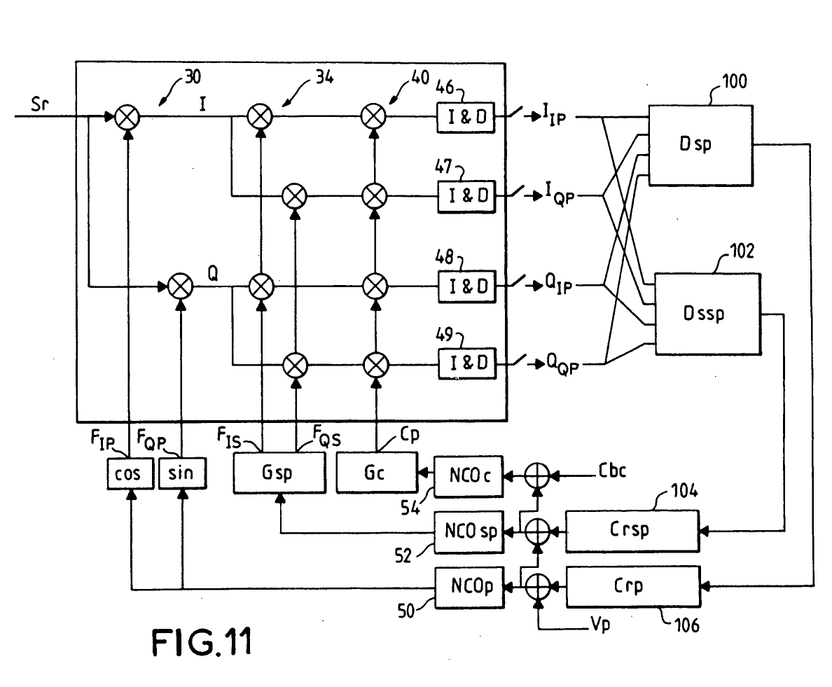

FIGS. 10 and 11 represent two receivers in which the slaving of the carrier phase and subcarrier phase are carried out independently at the same time as the code;

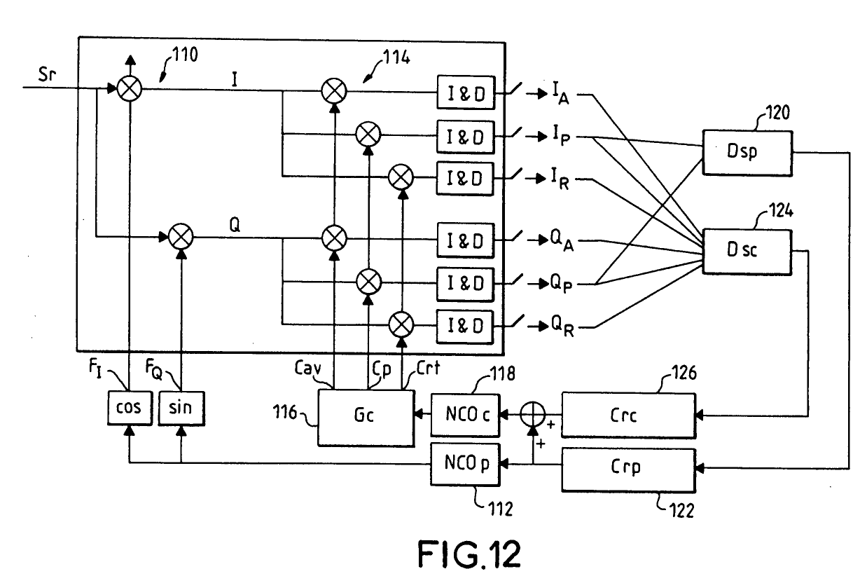

FIG. 12 shows a receiver in a final phase of tracking without elimination of the subcarrier;

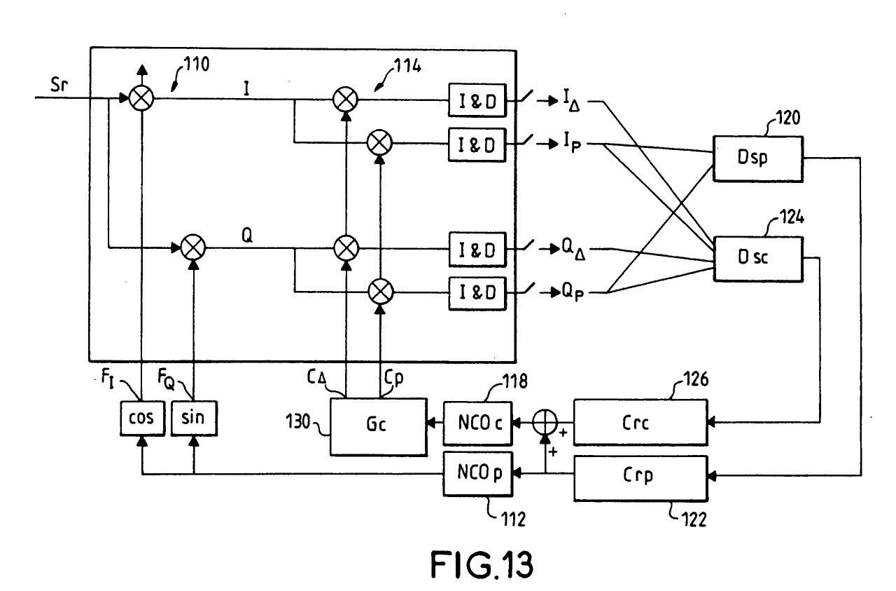

FIG. 13 shows a variant of the receiver of FIG. 12;

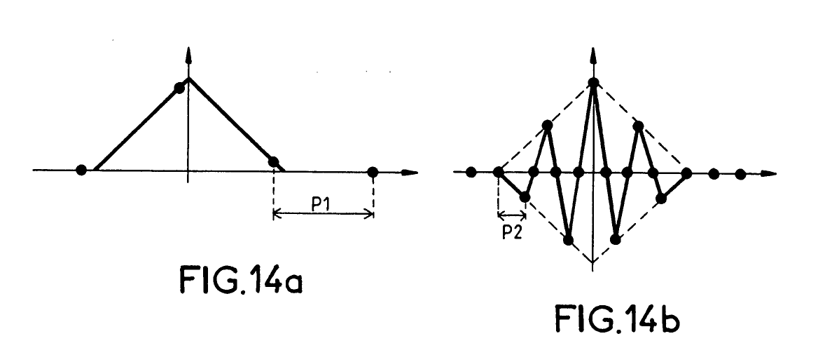

FIG. 14a shows the minimum interval P1 necessary for the code scanning to obtain energy detection with elimination of the subcarrier;

FIG. 14b shows the minimum interval P2 necessary without elimination of the carrier.

We shall, subsequently, describe receivers implementing the method of acquisition of a BOC signal according to the invention and by the two processes cited previously.

FIG. 4 shows a receiver implementing the method of acquisition according to the invention, during the reception of a spread band signal of BOC type, by the first process, with a local code and local subcarriers that are synchronous: according to this first process, the phase of the local subcarrier is a multiple of the local code. FIG. 4 represents the elements necessary during the acquisition phase.

The receiver comprises:
a channel for in-phase and quadrature carrier correlation 30 between the signals received Sr from the positioning satellites and two respective local carriers F_{IP}, F_{QP}. These local quadrature carriers (cos, sin) are generated by a carrier digitally controlled oscillator 32 (NCO p) of the receiver;
a channel for in-phase and quadrature subcarrier correlation 34 between the signals I_{PT} and Q_{PT} at the output of the carrier correlation channel and two respective local subcarriers F_{IS}, F_{QS} in-phase and quadrature;
a channel for code correlation 40 between the signals at the output of the subcarrier correlation channel and the local codes provided by the digital generator of local codes 36,
a code oscillator NCO c 38 driving a generator of local subcarriers Gsp 42 and the generator of local codes Gc 36;
a detection of energy 44 of the signals I_{IP}, I_{QP}, Q_{IP}, Q_{QP} at the output of the code correlation channel after integration by respective integrators 46, 47, 48, 49.

We shall, subsequently, describe the manner of operation of the receiver.

FIGS. 5a, 5b, 5c, 5d and 5e show respectively the code received of BPSK type without modulation by the subcarrier and the code received of BOC type with the modulation by the subcarrier, the local code generated by the local code generator Gc 36 and the two in-phase and quadrature local subcarriers.

FIGS. 5f, 5g, 5h, respectively represent the autocorrelation function with the in-phase subcarrier, with the quadrature subcarrier and the envelope Ev of the energy detection at the output of the correlation channels.

In a first phase of acquisition, the signals at the output of the carrier correlation channel 30, comprising the subcarrier of the signal BOC, are applied to the subcarrier correlation channel 34 demodulating the subcarrier. The signals at the output of the subcarrier correlation channel 34 are applied to the code correlation channel 40 providing after integration the signals I_{IP}, I_{QP}, Q_{IP}, Q_{QP} to the energy detector 44.

The sum of the energies gathered on each of the in-phase and quadrature subcarrier channels makes it possible to detect a unique and unambiguous energy peak Pu (see FIG. 5h) identical to that that would be obtained with a signal comprising no subcarrier.

The sum of the energies E is given by the following relation:
E=Σ(I_{IP}²+I_{QP}²+Q_{IP}²+Q_{QP}²)

The sum E being a noncoherent sum of several samples over a time T which is a multiple of the coherent time Tc.

Two solutions of finding the energy are shown in FIG. 6:

First solution: the code assumptions are tested by making the local code slip continuously (scanning, curve Bc of FIG. 6). In this case, the subcarrier slips too and a duration of coherent integration which is less than the duration of scanning of a portion of a subcarrier peak (a quarter subcarrier wavelength will be taken) is necessary so as not to loss too much energy and reduce the capacity to detect the signal in a noisy environment.

Second solution: the fixed assumptions about the code are tested (curve Bi of FIG. 6) by making phase jumps Δφ (times Td1, Td2, Td3, . . . Tdn) between the integrations. In this case, the subcarrier phase remains constant and there is no loss of energy. The phase jumps Δφ may be generated by accelerating the speed of the code local oscillator (NCO c) over short durations Δt between two integrations, or by another means consisting in instantaneously changing the phase at the output of the NCO c and by incrementing the code generator. A test of energy detection is performed after integration at each incrementation or phase jump Δφ.

FIG. 7 shows another receiver implementing the method of acquisition according to the invention, during the receipt of a spread band signal of BOC type, by the second process, with a local code and local subcarriers that are asynchronous.

The receiver comprises three oscillators, a local carrier oscillator 50 NCO p digitally controlled and generating the two in-phase and quadrature local carriers F_{IP}, F_{QP} for the carrier correlation channel 30, a subcarrier oscillator 52 NCO sp digitally controlled and generating, by a generator of local subcarriers Gsp, the two local subcarriers F_{IS}, F_{QS}, in-phase and quadrature, for the subcarrier correlation channel 34 and a code oscillator 54 providing via a code generator Gc the local code of the code correlation channel 40 of the receiver.

The receiver of FIG. 7 like that described above comprises
the channel for in-phase and quadrature carrier correlation 30 between the signals received Sr from the positioning satellites and the two respective local carriers F_{IP}, F_{QP} generated by the carrier digitally controlled oscillator 50 (NCO p) of the receiver.
the channel for in-phase and quadrature subcarrier correlation 34 between signals at the output of the carrier correlation channel and the two respective local subcarriers F_{IS}, F_{QS}, in-phase and quadrature, generated by the digitally controlled local code and local subcarrier oscillator 52;
the channel for code correlation 40 between the code of the satellite received and the local codes provided by the digital generator of local codes 54.
an energy detection 44 of the signals I_{IP}, I_{QP}, Q_{IP}, Q_{QP} at the output of the code correlation channel after integration by respective integrators 46, 47, 48, 49.

As described previously, in a first phase of acquisition, the signals at the output of the carrier correlation channel 30 comprising the subcarrier of the signal BOC, are applied to the subcarrier correlation channel 34 demodulating the subcarrier. The signals at the output of the subcarrier correlation channel are applied to the code correlation channel 40 providing after integration the signals I_{IP}, I_{QP}, Q_{IP}, Q_{QP} to the energy detector DEng 44.

The sum of the energies gathered on each of the subcarrier channels (in-phase and quadrature) makes it possible to detect a single unambiguous energy peak identical to that which would have been obtained with a signal comprising no subcarrier.

The sum of the energies E is given by the following relation:
E=Σ(I_{IP}²+I_{QP}²+Q_{IP}²+Q_{QP}²)

The sum E being a noncoherent sum of several samples over a time T which is a multiple of a coherent time Tc.

The acquisition of the signal is performed by making the code slip so as to scan the assumptions to be tested independently of the phase of the subcarrier. The latter is rendered coherent with the carrier phase speed so as to take account of the Doppler.

In a variant of the receiver of FIG. 7, the subcarrier local oscillator is dispensed with and a single oscillator (NCO) is used for the carrier and the subcarrier, by dividing the carrier phase by the ratio of the wavelengths to obtain the phase of the subcarrier.

The receivers are configured so as to perform the following correlation operations:
I_{IP}=∫_{[nT,(n+1)T]}S_{Received}·cos(φ(t))·SP_{In phase}(t)·Code_{Punctual}(t)dt
I_{QP}=∫_{[nT,(n+1)T]}S_{Received}·cos(φ(t))·SP_{Quadrature}(t)·Code_{Punctual}(t)dt
Q_{IP}=∫_{[nT,(n+1})T]S_{Received·sin(φ(}t))·SP_{In phase}(t)·Code_{Punctual}(t)dt
Q_{QP}=∫_{[nT,(n+1)T]}S_{Received}·sin(φ(t))·SP_{Quadrature}(t)·Code_{Punctual}(t)dt
with:
T Duration of coherent integration
cos(φ(t)), sin(φ(t)) In-phase and quadrature local carriers
SP_{In phase}, SP_{Quadrature} In-phase and quadrature local subcarrier
Code_{Punctual}(t) Local punctual code

For the slaving of the phase of the code (transition and tracking) the same operation is performed but with an early Cav, late Crt, or “delta” local code, the delta code being the early code minus the late code.

The multiplication being associative and commutative, this operation can be carried out in several ways:
the signal received is multiplied successively by the local carrier, the local subcarrier and then the local code;
the signal received is multiplied by the product of the local carrier, the local subcarrier and the local code.
etc.

Coherent and noncoherent integration:

Definition:

Coherent integration: Iₙ=∫_{[nT,(n+1)}T]S_{Received}(t)·S_{Local in phase (t)dt}
Qₙ=∫_{[nT,(n+1)T]}S_{Received}(t)·S_{Local Quadrature}(t)dt

Noncoherent integration: E=Σ_{n=1 to N}(Iₙ²+Qₙ²)

Energy losses: sinc² (Δ_{Doppler}. T/2) with:
S_{Local in phase}(t)=cos(ωt).SP_{In phase}(t).Code_{Punctual}(t)
S_{Local quadrature}(t)=sin(ωt).SP_{In phase}(t).Code_{punctual}(t)

Δ_{Doppler}: Doppler error between the local carrier and the carrier received

The duration of coherent integration T is limited by the Doppler which induces energy losses.

Two short a duration of coherent integration induces quadratic losses which degrade the signal-to-noise ratio and require an overly long total (noncoherent) integration time.

A long duration of integration reduces the width of the Doppler peak (in practice the width of the Doppler peak at 3 dB is equal to ½T) and therefore compels the processing of more Doppler assumptions.

The choice of the duration of coherent integration results from an optimization of the time for searching for the energy by a compromise between the time spent on each Doppler assumption and the number of Doppler assumptions.

In the case where the subcarrier is made to slip with the code it is necessary to take account also of energy losses. The duration of coherent integration may have to be reduced if the scanning speed makes the subcarrier phase undergo more than a quarter of a revolution over this duration of integration. Hence the benefit of jumping (first process) or of not making the subcarrier slip (second process).

Subsequently, we shall describe the phase of transition to the phase of tracking the receivers. Specifically, once the energy has been found, it is necessary to refine the synchronization of the carrier frequency and of the subcarrier phase and local code phase so as to be able to switch to nominal search and benefit from the advantages of the BOC modulation (precision).

One begins by closing the code loop by virtue of the early correlation and late correlation channels.

FIG. 8 shows the receiver of FIG. 4 during the phase of transition to tracking in the case where the local code and the local subcarrier are synchronous.

In this tracking phase, the receiver of FIG. 8 generates, on the basis of the signals I_{IA}, I_{IR}, I_{QA}, I_{QR}, Q_{IA}, Q_{IR}, Q_{QA}, Q_{QR} at the output of the integrators 80 of the respective code correlation channels, through a code discriminator 90 followed by a code corrector 92, commands to the code oscillator 38 aided by the carrier speed Vp.

The Doppler speed (Vp) applied to the digitally controlled carrier oscillator (NCO p) 32 is that found on completion of the search for the energy in the first phase of acquisition. In this case the duration of coherent integration must be compatible with the residual Doppler error on completion of the energy search phase and also the homing speed applied to the subcarrier.

FIG. 9 shows a receiver comprising the three digitally controlled oscillators 50, 52, 54, during the phase of tracking in the case where the local code and the local subcarrier are asynchronous.

In this tracking phase, the receiver of FIG. 9 generates, on the basis of the signals I_{IA}, I_{IR}, I_{QA}, I_{QR}, Q_{IA}, Q_{IR}, Q_{QA}, Q_{QR} at the output of the integrators 80 of the respective code correlation channels, through a code discriminator 90 followed by a code corrector 92, commands to the code oscillator (NCO c) 54 aided by the carrier speed Vp.

The Doppler speed (Vp) applied to the carrier oscillator (NCO p) 50 and subcarrier oscillator (NCO sp) 52 digitally controlled is that found on completion of the search for the energy in the acquisition phase.

The duration of coherent integration is also unchanged.

In this case the speeds of the carrier and subcarrier oscillators NCO are identical. It is also possible to have a single NCO.

The code discriminator provides a signal:
ε_{code}=(I_{IA}²+I_{QA}²+Q_{IA}²Q_{QA}²−I_{IR}²+I_{QR}²Q_{IR}²+Q_{QR}²)/Energy with Energy=I_{IA}²+I_{QA}²+Q_{IA}²+Q_{QA}²+I_{IR}²+I_{QR}²+Q_{IR}²+Q_{QR}²

FIGS. 10 and 11 represent variants of the receivers of FIGS. 8 and 9 respectively, for the variant of FIG. 10, with a local code and subcarriers that are synchronous and, for the variant of FIG. 11, with a local code and subcarriers that are asynchronous.

In these variants, the slaving of the carrier phase and subcarrier phase is carried out independently at the same time as the code (processing carried out in parallel). The benefit of the process is to refine the measure of the Doppler and of the carrier phase so as to aid the code loop and be able to reduce the predetection band thereof (inverse of the duration of coherent integration) and noise band thereof. One thus obtains a better final precision of the code, thereby decreasing the risk of switching to nominal BOC tracking on a lateral peak of the autocorrelation function inducing a bias in the measurement.

In the variant of FIG. 10, (with a local code and subcarriers that are synchronous) the receiver comprises:
the channel for carrier correlation 30 in-phase and quadrature between the signals received Sr from the positioning satellites and the two respective local carriers F_{IP}, F_{QP} generated by the digitally controlled carrier oscillator (NCO p) 32 of the receiver.
the channel for subcarrier correlation 34 in-phase and quadrature between signals at the output of the carrier correlation channel and the two respective local subcarriers F_{IS}, F_{QS} in-phase and quadrature generated by the subcarrier local oscillator Gsp and the local code generator Gc driven by the code oscillator (NCO c) 38 digitally controlled;
the channel for code correlation 40 between the code of the satellite received and the local code provided by the digital generator of local codes Gc driven by the code oscillator (NCO c) 38 digitally controlled;
a carrier discriminator 94 (Dsp) followed by a carrier loop corrector 96 (Crp) providing on the basis of the signals I_{IP}, I_{QP}, Q_{IP}, Q_{QP} at the output of the code correlation channel after integration by respective integrators 46, 47, 48, 49 a signal for controlling the carrier oscillator aided by the Doppler speed Vp.

The carrier discriminator provides a signal:
ε_{carrier}=(Q_{I}.I_{I}+Q_{Q}.I_{Q})/(I_{IP}²+I_{QP}²+Q_{IP}²+Q_{QP}²)
in a variant:
ε_{carrier}=Arctan[2(Q_{I}.I_{I}+Q_{Q}.I_{Q})/(I_{I}.I_{I}+I_{Q}.I_{Q}−Q_{I}.Q_{I}−Q_{Q}_{Q}.Q_{Q})]

In the variant of FIG. 11, (with a local code and subcarriers that are asynchronous) the receiver comprises:
the channel for carrier correlation 30 in-phase and quadrature between the signals received Sr from the positioning satellites and the two respective local carriers F_{IP}, F_{QP} generated by the digitally controlled carrier oscillator (NCO p) 50 of the receiver.
the channel for subcarrier correlation 34 in-phase and quadrature between signals at the output of the carrier correlation channel and the two respective local subcarriers F_{IS}, F_{QS} in-phase and quadrature generated by the subcarrier local oscillator Gsp driven by the subcarrier digitally controlled oscillator (NCO sp) 52 digitally controlled;
the channel for code correlation 40 between the code of the satellite received and the local codes provided by the digital generator of local codes Gc driven by the code oscillator (NCO c) 54 digitally controlled;
a carrier discriminator 100 (Dsp) followed by a carrier loop corrector 106 (Crp), a subcarrier discriminator 102 (Dssp) followed by a subcarrier loop corrector 104 (Crsp) providing respectively on the basis of the signals I_{IP}, I_{QP}, Q_{IP}, Q_{QP} at the output of the code correlation channel after integration by respective integrators 46, 47, 48, 49 a signal for controlling the carrier oscillator 50 aided by the Doppler speed Vp and a signal for controlling the subcarrier oscillator 52.

The carrier discriminator provides a signal:
ε_{subcarrier}=(I_{Q}.I_{I}+Q_{Q}.Q_{I})/(I_{IP}²+I_{QP}²+Q_{IP}²+Q_{QP}²)
in a variant:
ε_{subcarrier}=Arctan[2(I_{Q}.I_{I}+Q_{Q}.Q_{I})/(I_{I}.I_{I}+Q_{I}.Q_{I}−I_{Q}.I_{Q}−Q_{Q}.Q_{Q})]
Proof:

Let φ be the carrier phase deviation and θ the subcarrier phase deviation (regarded as a sinusoidal signal)
I_{IP}=A.cos φ.cos θI_{QP}=A.cos φ.sin θ
Q_{IP}=A.sin φ.cos θQ_{QP}=A.sin φ.sin θ
(A: amplitude after correlation with the punctual local code)
I_{Q}.I_{I}+Q_{Q}.Q_{I}=A².sin θ.cos θ(cos φ²+sin φ²)=A².sin θ.cos θ=A².½ sin 2θ
I_{I}.I_{I}+Q_{I}.Q_{I}=A².cos θ.cosθ (cos φ²+sin φ²)=A².cos θ.cos θ
I_{Q}.I_{Q}+Q_{Q}.Q_{Q}=A².sin θ.sin θ(cos φ²+sin φ²)=A².sin θ.sin θ
I_{I}.I_{I}+Q_{I}.Q_{I}−I_{Q}.I_{Q}−Q_{Q}.Q_{Q}=A² (cos θ.cos θ−sin θ.sin θ)=A² cos 2θ
Q_{I}.I_{I}+Q_{Q}.I_{Q}=A².sin φ.cos φ(cos θ²+sin θ²)=A².sin φ.cos φ=A².½ sin 2φ
I_{I}.I_{I}+I_{Q}.I_{Q}=A².cos φ.cosφ(cos θ²+sin θ²)=A².cos φ.cosφ
Q_{I}.Q_{I}+Q_{Q}Q_{Q}=A².sin φ.sinφ(cos θ²+sin θ²)=A².sin φ.sinφ
I_{I}.I_{I}+I_{Q}.I_{Q}−Q_{I}.Q_{I}−Q_{Q}.Q_{Q}=A²(cos φ.cos φ−sin φ.sinφ)=A².cos 2φ
I_{IP}²+I_{QP}²+Q_{IP}²+Q_{QP}²=A²

After the phase of transition to tracking, the receiver switches to the final phase of tracking.

After a convergence time to be determined which depends on the characteristics of the dynamics, the noise level and the gains of the loops, and if the precision the slaving of the phase of the code is deemed sufficient, we switch to nominal BOC tracking: the code is replaced with the code modulated by the subcarrier.

FIG. 12 shows the receiver in this final phase, without elimination of subcarrier.

The receiver essentially comprises in this tracking phase:
a channel for carrier correlation 110, in-phase and quadrature between the signal received Sr and two respective quadrature local carriers F_{I}, F_{Q} generated by a carrier local oscillator 112 digitally controlled;
a code correlation channel 114 comprising the subcarrier (signal of BOC type as in FIG. 5b), a code generator 116 driven by the code oscillator 118 providing the code correlation channel 114 with the early Cav, late Crt code and punctual code Cp signals.
a carrier discriminator 120 (Dsp) followed by a carrier loop corrector 122 (Crp), a code discriminator 124 (Dsc) followed by a code loop corrector 126 (Crc) respectively providing on the basis of the signals I_{IP}, I_{QP}, Q_{IP}, Q_{QP} at the output of the code correlation channel after integration, a carrier speed signal for controlling the carrier oscillator 112 and a code speed signal for controlling the code oscillator 118 aided by the carrier speed.

In this last phase the manner of operation is that of a receiver of BOC type.

The code discriminator providing a signal:
ε_{code}=[(I_{A}−I_{R}).I_{P}+(Q_{A}−Q_{R}).Q_{P})]/(I_{P}²+Q_{P}²)]
or ε_{code}=[(I_{A}−I_{R})²+(Q_{A}−Q_{R})²]/[(I_{A}+I_{R})²+(Q_{A}+Q_{R})²]

FIG. 13 shows the receiver of BOC type in a variant of the receiver of FIG. 12, in the final phase, without subcarrier elimination. In this variant of FIG. 13, the correlation via the early and late codes is replaced with a correlation via a delta code CA, obtained by differencing the early Cav and late Crt codes.

In the configuration of the receiver of FIG. 13, the code correlation channel 114 comprising the subcarrier (signal of BOC type as in FIG. 5b), a code generator 130 driven by the code oscillator 118 provides the code correlation channel 114 with the delta code CΔ and punctual code Cp signals.

The code discriminator providing a signal:
ε_{code}=(I_{Δ}.I_{P}+Q_{Δ}.Q_{P})/(I_{P}²+Q_{P}²)

It may be noted that the early and late local BOC codes obtained by coherently advancing or delaying the local code and the local subcarrier may be replaced with a punctual local code modulated by an early and late subcarrier.

In the method according to the invention, on the time of integration of the correlation depends the duration of the acquisition phase and the capacity to find the useful signal in a noisy environment. The best compromise will be obtained by maximizing the signal-to-noise ratio at the output of the energy detection (the higher the signal-to-noise ratio, the shorter the total integration time). Hence the benefit of the process with respect to the processing that considers only a single lobe, that loses 3 dB.

The duration of the acquisition depends also on the sampling interval: a fine sampling interval increases the number of assumptions to be tested. Hence, the benefit of the process with respect to the scanning without elimination of subcarrier which would impose a code sampling interval equal to half the width of the main peak of the autocorrelation function.

FIG. 14a shows the minimum interval P1 necessary for the code scanning to obtain energy detection with elimination of the subcarrier. FIG. 14b shows the minimum interval P2 necessary without elimination of the carrier. The minimum interval P1 necessary is much larger than the minimum interval P2, so fewer code assumptions are required to find energy in the case of elimination of the subcarrier.

1. A method of acquisition of radio signals transmitted by a satellite-based positioning system having a subcarrier, the acquisition of the signals being performed by a receiver having a channel for carrier correlation in-phase and quadrature, between the signal received and two respective in-phase and quadrature local carriers generated by a digitally controlled carrier local oscillator a channel for subcarrier correlation on the basis of the signals at the output of the channel for carrier correlation with a local subcarrier and a channel for code correlation on the basis of the signals at the output of the channel for subcarrier correlation with the local codes provided by a digital generator of local codes; comprising the steps of: in a first phase of acquisition, a channel for subcarrier correlation has two channels, in-phase and quadrature, between signals at the output of the carrier correlation channel and two respective local subcarriers, in-phase and quadrature, with respect to the local code that are generated by a digitally controlled subcarrier local oscillator, the receiving being configured in such a way that in this first phase of acquisition of the signals, an energy search is performed by the detection of a correlation peak.

2. The method of acquisition of radiofrequency signals as claimed in claim 1, wherein the receiver is configured such that during a first phase of acquisition of the signals, the phase of the subcarrier of the signal received is eliminated by summing the in-phase and quadrature powers of subcarriers at the outputs of correlation channels then in the same way, a search for an unambiguous correlation peak is performed.

3. The method of acquisition of radiofrequency signals as claimed in claim 1, wherein in a second phase of acquisition of the signal received, a slaving of the loops is carried out on the basis of the outputs of the correlators causing convergence of the local code to the maximum of the code correlation peak, independently of the subcarrier.

4. The method of acquisition of radiofrequency signals as claimed in claim 1, wherein the local code and the local subcarrier are synchronous, the phase of the local subcarrier being a multiple of the local code, the two phases arising from the same digitally controlled local oscillator (NCO) controlled in terms of speed and operating as an integrator.

5. The method of acquisition of radiofrequency signals as claimed in claim 1, wherein the local code and the local subcarrier are asynchronous.

6. The method of acquisition of radiofrequency signals as claimed in claim 4, wherein in the first phase of acquisition, the signals at the output of the carrier correlation channel comprising the subcarrier of the signal BOC, are applied to the subcarrier correlation channel demodulating the subcarrier, the signals at the output of the subcarrier correlation channel being applied to the code correlation channel providing after integration signals I_{IP}, I_{QP}, Q_{IP}, Q_{QP} to an energy detector, the sum of the energies gathered on each of the in-phase and quadrature subcarrier channels making it possible to detect a unique and unambiguous energy peak identical to that which would have been obtained with a signal comprising no subcarrier, the sum of the energies E being given by the relation:
E=Σ(I_{IP}²+I_{QP}²+Q_{IP}²+Q_{QP}²),
the sum E being a noncoherent sum of several samples over a time T greater than or equal to a coherent time Tc.

7. The method of demodulating radiofrequency signals as claimed in claim 6, wherein in order to find the energy E, the code assumptions are tested by causing the local code to slip continuously, the subcarrier slipping too and in that the duration of coherent integration is less than the duration of scanning of a portion of a subcarrier peak.

8. The method of demodulating radiofrequency signals as claimed in claim 6, wherein in order to find the energy E, the fixed assumptions about the code are tested, by making phase jumps (Δφ) between the integrations, the phase of the subcarrier remaining constant.

9. The method of acquisition of radiofrequency signals as claimed in claim 8, wherein the phase jumps (Δφ) may be generated by accelerating the speed of the code local oscillator (NCO c) over short durations (Δt) between two integrations.

10. The method of acquisition of radiofrequency signals as claimed in claim 8, wherein the phase jumps (Δφ) may be generated by a means consisting in instantaneously changing the phase at the output of the NOC and by incrementing the code generator Gc and in that an energy detection test is performed with each incrementation or phase jump.

11. The method of acquisition of radiofrequency signals as claimed in claim 5, wherein the receiver comprises:
three oscillators, a local carrier oscillator NCO p controlled digitally and generating the two in-phase and quadrature local carriers F_{IP}, F_{QP} for the carrier correlation channel 30, a subcarrier oscillator NCO sp digitally controlled and generating, by a generator of local subcarriers Gsp, the two local subcarriers F_{IS}, F_{QS} in-phase and quadrature for the subcarrier correlation channel and a code oscillator providing via a code generator Gc the local code of the code correlation channel of the receiver;
an energy detection DEng of the signals I_{IP}, I_{QP}, Q_{IP}, Q_{QP} at the output of the code correlation channel after integration by respective integrators and in that in the first phase of acquisition, the signals at the output of the carrier correlation channel comprising the subcarrier of the signal BOC, are applied to the subcarrier correlation channel demodulating the subcarrier, the signals at the output of the subcarrier correlation channel being applied to the code correlation channel providing after integration the signals I_{IP}, I_{QP}, Q_{IP}, Q_{QP} to the energy detector DEng, the sum of the energies gathered on each of the subcarrier channels (in-phase and quadrature) making it possible to detect a unique and unambiguous energy peak identical to that which would have been obtained with a signal comprising no subcarrier.

12. The method of acquisition of radiofrequency signals as claimed in claim 11, wherein the sum of the energies E is given by the following relation:
EΣ(I_{IP}²+I_{QP}²+Q_{IP}²+Q_{QP}²),
the sum E being a noncoherent sum of several samples over a time T greater than or equal to a coherent time Tc and in that the acquisition of the signal is performed by making the code slip so as to scan the assumptions to be tested independently of the phase of the subcarrier, the latter being rendered coherent with the carrier phase speed so as to take account of the Doppler.

13. The method of acquisition of radiofrequency signals as claimed in claim 5, wherein a single oscillator (NCO) is used for the carrier and the subcarrier.

14. The method of acquisition of radiofrequency signals as claimed in claim 1, wherein the receivers are configured so as to do the following correlation operations:
I_{IP=∫}_{[nT,(n+1)T]}S_{Received}.cos (φ(t)).SP_{In phase}(t).Code_{Punctual}(t)dt
I_{QP}=∫_{[nT,(n+1)T]}S_{Received}. cos (φ(t)).SP_{Quadrature}(t).Code_{Punctual}(t)dt
Q_{IP}=∫_{[nT,(n+1)T]}S_{Received}sin (φ(t)).SP_{In, phase}(t).Code_{Punctual}(t)dt
Q_{QP}=∫_{[nT,(n+1)T]}S_{Received}. sin (φ(t)).SP_{Quadrature}(t).Code_{Punctual}(t)dt
with:
T Duration of coherent integration
cos(φ(t)),sin(φ(t)) In-phase and quadrature local carriers
SP_{In phase}, SP_{Quadrature} In-phase and quadrature local subcarrier
Code_{Punctual}(t) Local punctual code

15. The method of acquisition of radiofrequency signals as claimed in claim 4, wherein in a phase of transition to the phase of tracking of the receivers, in the case where the local code and the local subcarrier are synchronous and once the energy has been found, we begin by closing the code loop by virtue of early correlation and late correlation pathways, the receiver generating, on the basis of the signals I_{IA}, I_{IR}, I_{QA}, I_{QR}, Q_{IA}, Q_{IR}, Q_{QA}, Q_{QR}, at the output of integrators of the respective code correlation channels, through a code discriminator followed by a code corrector, commands to the code oscillator aided by the carrier speed, the Doppler speed applied to the digitally controlled carrier oscillator (NCO p) being that found on completion of the search for the energy in the first phase of acquisition.

16. The method of acquisition of radiofrequency signals as claimed in claim 15, wherein the duration of coherent integration must be compatible with the Doppler residual error on completion of the energy search phase and also with the homing speed applied to the subcarrier.

17. The method of acquisition of radiofrequency signals as claimed in claim 5, the receiver comprising the three digitally controlled oscillators, wherein during the tracking phase in the case where the local code and the local subcarrier are asynchronous, the receiver generates, on the basis of the signals I_{IA}, I_{IR}, I_{QA}, I_{QR}, Q_{IA}, Q_{IR}, Q_{QA}, Q_{QR}, at the output of integrators of the respective code correlation channels, through a code discriminator followed by a code corrector, commands to the code oscillator (NCO c) aided by the carrier speed, the Doppler speed applied to the digitally controlled carrier oscillator (NCO p) and subcarrier oscillator (NCO sp) being that found on completion of the search for the energy in the acquisition phase, the duration of coherent integration also being unchanged, the code discriminator providing a signal:
ε_{code}=(I_{IA}²+I_{QA}²+Q_{IA}²+Q_{QA}²−I_{IR}²+I_{QR}²+Q_{IR}²+Q_{QR}²)/Energy with
Energy=I_{IA}²+I_{QA}²+Q_{IA}²+Q_{QA}²+I_{IR}²+I_{QR}²+Q_{IR}²Q_{QR}²

18. The method of acquisition of radiofrequency signals as claimed in claim 5, wherein the receiver comprises a single NCO, the speeds of the carrier and subcarrier oscillators NCO being identical.

19. The method of acquisition of radiofrequency signals as claimed in claim 4, wherein with a local code and subcarriers that are synchronous the receiver comprises:
the channel for code correlation 40 between the code of the satellite received and the local code provided by the digital generator of local codes Gc, driven by the digitally controlled code oscillator (NCO c);
a carrier discriminator (Dsp) followed by a carrier phase loop (Crp) providing on the basis of the signals I_{IP}, I_{QP}, Q_{IP}, Q_{QP} at the output of the code correlation channel after integration by respective integrators a signal for controlling the carrier oscillator aided by the Doppler speed Vp.

20. The method of acquisition of radiofrequency signals as claimed in claim 19, wherein the carrier discriminator provides a signal:
ε_{carrier}=(Q_{I}.I_{I}+Q_{Q}.I_{Q})/(I_{IP}²+I_{QP}²+Q_{IP}²+Q_{QP}²)

21. The method of acquisition of radiofrequency signals as claimed in claim 19, wherein the carrier discriminator provides a signal:
ε_{carrier}=Arctan[2(Q_{I}.I_{I}+Q_{Q}.I_{Q})/(I_{I}.I_{I}+I_{Q}.I_{Q}−Q_{I}.Q_{I}−Q_{Q}.Q_{Q})]

22. The method of acquisition of radiofrequency signals as claimed in claim 5, wherein with a local code and subcarriers that are asynchronous the receiver comprises:
a carrier discriminator (Dsp) followed by a carrier loop corrector (Crp), a subcarrier discriminator (Dssp) followed by a subcarrier loop corrector 104 (Crsp) providing respectively on the basis of the signals I_{IP}, I_{QP}, Q_{IP}, Q_{QP} at the output of the code correlation channel, after integration by respective integrators a signal for controlling the carrier oscillator aided by the Doppler speed Vp and a signal for controlling the subcarrier oscillator.

23. The method of acquisition of radiofrequency signals as claimed in claim 22, wherein the subcarrier discriminator provides a signal:
ε_{subcarrier}=(I_{Q}.I_{I}+Q_{Q}.Q_{I})/(I_{IP}²+I_{QP}²+Q_{IP}²+Q_{QP}²)

24. The method of acquisition of radiofrequency signals as claimed in claim 22, wherein the subcarrier discriminator provides a signal:
ε_{subcarrier}=Arctan[2(I_{Q}.I_{I}+Q_{Q}.Q_{I})/(I_{I}.I_{I}+Q_{I}.Q_{I}−I_{Q}.I_{Q}−Q_{Q}.Q_{Q})]

25. The method of acquisition of radiofrequency signals as claimed in claim 17, wherein after the phase of transition to tracking, the receiver switches to the final phase of nominal BOC tracking by replacing the code with the code modulated by the subcarrier.

26. The method of acquisition of radiofrequency signals as claimed in claim 25, wherein the receiver comprises a code correlation channel comprising the subcarrier, a code generator driven by the code oscillator providing the code correlation channel with the early Cav, late Crt code and punctual code Cp signals, the code discriminator providing a signal:
ε_{code}=[(I_{A}−I_{R}).I_{P}+(Q_{A}−Q_{R).}Q_{P})]/(I_{P}²+Q_{P}²)]
or ε_{code}=[(I_{A}−I_{R})²+(Q_{A}−Q_{R})²]/[(I_{A}+I_{R})²+(Q_{A}+Q_{R})²]

27. The method of acquisition of radiofrequency signals as claimed in claim 25, wherein the receiver comprises a code correlation channel comprising the subcarrier, a code generator driven by the code oscillator providing the code correlation channel with the delta code CΔ and punctual code Cp signals, the delta code CΔ being obtained by differencing the early Cav and late Crt codes, the code discriminator providing a signal:
ε_{code}=(I_{Δ}.I_{P}+Q_{Δ}.Q_{P})/(I_{P}²+Q_{P}²)
